(19) United States
(12) Patent Application Publication
(10) Pub. No.: US 2011/0077814 A1
(43) Pub. Date: Mar. 31, 2011

(54) SAFETY SCANNER

(75) Inventor: Manfred HABERER, Riegel (DE)

(73) Assignee: SICK AG, Waldkirch (DE)

(21) Appl. No.: 12/858,462

(22) Filed: Aug. 18, 2010

(30) Foreign Application Priority Data
Sep. 28, 2009 (EP) 09171525.0

(51) Int. Cl. G05D 1/00; G06F 7/00

(52) U.S. Cl. 701/28

(57) ABSTRACT

The invention relates to a safety scanner for the securing of the environment of a vehicle, in particular of a driverless transport system, comprising a light transmitter, a light deflection unit for the deflection of the light into a protected field to be monitored, a receiver for the provision of received signals in dependence on light remitted at objects present in the field of view of the scanner, an evaluation unit for the evaluation of the received signals and of the incremental encoder signals and for the provision of a safety signal, a first input connected to a vehicle speed determination unit for the reception of first signals which are representative of a vehicle speed and comprising switchover means for the safe switching over between at least two different protected fields in dependence on the vehicle speed. To provide a safety scanner with which components can be saved and which is of simple construction, it is proposed that a second input is connected to the vehicle speed determination unit for the reception of desired speed signals of the vehicle and the vehicle speed determination unit has comparison means with which an actual speed can be compared with a desired speed on the basis of the first signals and of the desired speed signals and the safety signal can also be output in dependence on this comparison.

The invention relates to a safety scanner in accordance with the preamble of claim 1 as well as to a method for the securing of the environment of a vehicle.

Laser safety scanners such as are known from DE 43 40 756 A1 are frequently used for the monitoring of work spaces. A light beam generated by a laser is deflected via a light deflection unit into a protected zone and is remitted there by an object which may be present. The remitted light arrives back at the laser scanning unit again and is detected by a receiver there. The light deflection unit is designed to be pivotable or rotatable as a rule such that the light beam generated by the laser periodically sweeps over a protected field generated by the pivot movement or rotational movement. If a light signal remitted by the object is received from the protected zone, a conclusion can be drawn on the angular location of the object in the protected zone from the angular position of the deflection unit. If the transit time of individual laser light pulses is, for example, additionally monitored from the transmission up to the reception of a reflection at the object, it is additionally possible to draw a conclusion on the distance of the object from the laser scanner from the transit time using the speed of light. The location of an object can be determined and two-dimensional protected fields can, for example, be completely monitored using the angle and distance data. If an unpermitted object is located in the protected field, a corresponding warning signal or stop signal can be output by the evaluation unit of the scanner.

Such systems are used, for example, at machines in which a danger zone has to be monitored which may not be entered by an operator during the operation of the machine. If an unpermitted object—that is, for example, a leg of an operator—is determined in the danger zone with the help of the laser scanner, an emergency stop of the machine is effected. Such scanning systems as safety sensors have to work reliably and must therefore satisfy high safety demands, for example the EN13849 standard for machine safety and the device standard EN61496 for protective devices working in a contactless manner (ESPE=electrosensitive protective equipment).

A number of measures have to be taken to satisfy these safety standards such as reliable electronic evaluation by redundant, diverse electronics, function monitoring by, for example, monitoring the soiling of optical components, in particular of a front screen, and/or provision of individual test targets with defined degrees of reflection which have to be recognized at the corresponding scanning angles.

Such safety laser scanners are also used at so-called DTS (“driverless transport systems”) to prevent these transport systems from colliding with objects such as persons which cross their route. Since the collision danger is speed dependent, the laser scanner has adaptable protected field dimensions which can be switched over in dependence on the vehicle speed or which can be changed in another manner. For this purpose, the vehicle speed has to be determined “reliably” in the sense of the standards, for which purpose speed signals are necessary which have to satisfy technical safety demands with respect to single-fault safety.

The following approaches were previously possible. In a first known solution, the vehicle speed was detected by two independent incremental encoders which both send their speed signals to the scanner. The required failsafe character is obtained by the redundancy of signals which are “not safe” per se. In a second solution, “non-safe” speed signals of an incremental encoder are combined with a speed determination via the optical distance measurement of the laser scanner to determine the speed in a diverse manner in this way and thus to achieve the required reliability for the speed determination.

The first solution has the disadvantages that a redundant incremental encoder has to be provided in the vehicle which serves solely this purpose. This is particularly difficult to realize in a construction manner in small vehicles. Furthermore, the laser scanner has to have connection possibilities for two incremental encoders. Since each incremental encoder requires two input terminals for the transfer of the speed signals, construction space is also required at the laser scanner. Such a solution is associated with additional costs overall.

The second solution has the great disadvantage that a locally fixed object always has to be present in the field of view of the laser scanner for the optical speed determination. The laser scanner must e.g. always see a fixed wall or the like to be able to determine its speed against this. For this purpose, the laser scanner has to “know” which of the objects is a fixed object in the field of view. The evaluation of the received optical signals is therefore not only computationally intensive, but the areas of application for such a scanner are also limited and dependent on the environmental conditions.

Starting from this prior art, it is the object of the invention to provide a safety scanner with which the named disadvantages can be avoided.

This object is satisfied by a safety scanner having the features of claim 1 and by a method having the features of claim 6.

The safety scanner in accordance with the invention comprises:
a light transmitter;
a light deflection unit for the deflection of the light into a protected field to be monitored;
a receiver for the provision of received signals in dependence on light remitted at objects present in the field of view of the scanner;
an evaluation unit for the evaluation of the received signals and of the incremental encoder signals and for the provision of a safety signal:
a first input connected to a vehicle speed determination unit for the reception of first signals which are representative of a vehicle speed;
switching over means for the safe switching over between at least two different protected fields in dependence on the vehicle speed;
   wherein
   a second input is connected to the vehicle speed determination unit for the reception of desired speed signals of the vehicle and the vehicle speed determination unit has comparison means with which an actual speed can be compared with a desired speed on the basis of the first signals and of the desired speed signals and the safety signal can also be output in dependence on this comparison.

The safety scanner in accordance with the invention cooperates in an innovative manner with the vehicle controller and has desired speed signals transferred from it. In this manner, a switchover of the protected fields dependent on the vehicle speed and safe in the sense of the standards can take place in the vehicle speed determination unit of the safe evaluation unit, wherein the anyway present desired speed data of the one vehicle controller can be utilized and redundant external speed indicators can therefore be dispensed with. An incremental encoder could thus e.g. be saved, while a remaining incremental encoder delivers the first signals. The first signals, which are representative of a speed of the vehicle, could also be delivered otherwise, e.g. by means of a navigation system which in each case knows the exact location of the vehicle at any point in time.

The saving of an incremental encoder also saves further construction space in the vehicle.

The safety scanner in accordance with the invention is suitable for any DTS application and is not reliant on walls or the like in the field of view. Such an optical speed determination does not take place.

The desired speed can be transmitted in a single channel, e.g. by means of a binary pattern, to the safety scanner, so that less input terminals are required and construction space can be saved. Alternatively, it would also be conceivable that the first and/or second inputs are made for connection to a bus system so that the corresponding signals for the speed determination can be transferred via a bus system.

When “switching over” of protected fields is spoken of in the following, any kind of change of a protected field is meant by it, e.g. changes of the dimensions, changes of the alignment, step-like switching over, continuous changes and the like.

In accordance with the safety scanner in accordance with the invention, the method in accordance with the invention for the securing of the environment of a vehicle, in particular of a driverless transport vehicle, has the following steps:
transmission and deflection of a light beam into a protected field to be monitored;
reception of light remitted at objects present in the field of view of the scanner and provision of received signals;
evaluation of the received signals and provision of a safety signal in dependence thereon;
reception of first signals which are representative of an actual speed of the vehicle;
reception of desired speed signals of the vehicle;
determination of a vehicle speed by a comparison of the actual speed with the desired speed on the basis of the first signals and of the desired speed signals;
output of the safety signals also in dependence on this comparison;
switching over between at least two different protected fields in dependence on the vehicle speed.

In order only to switch over outside specific permitted tolerances and to avoid a constant switching over in limit regions, provision is made that the safety signal is output on a deviation of the actual speed from the desired speed by more than one limit value and a deviation of the desired speed from the actual speed above the limit value is tolerated for a limited time period.

To increase the safety, the higher speed is always used for the dimensioning of the protected field or for the selection of a protected field on a deviation of the desired speed from the actual speed. It is then ensured that sufficient time is available for an emergency stop.

The invention will be described in detail in the following with reference to an embodiment and to the drawing. There are shown in the drawing:

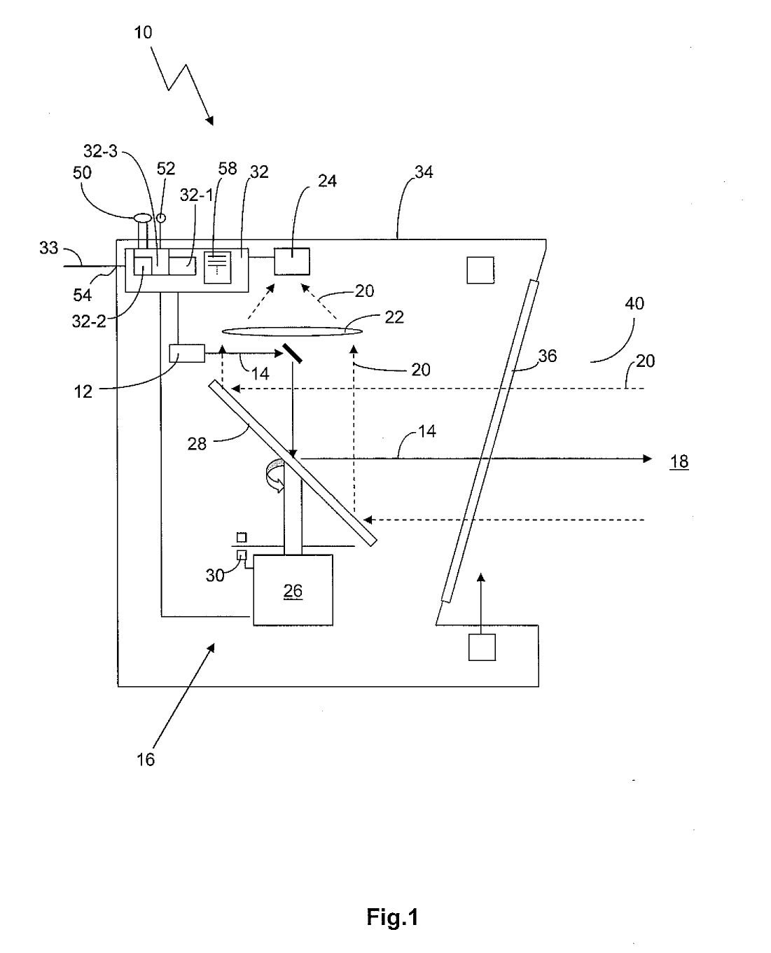

FIG. 1 a schematic representation of a safety scanner in accordance with the invention; and

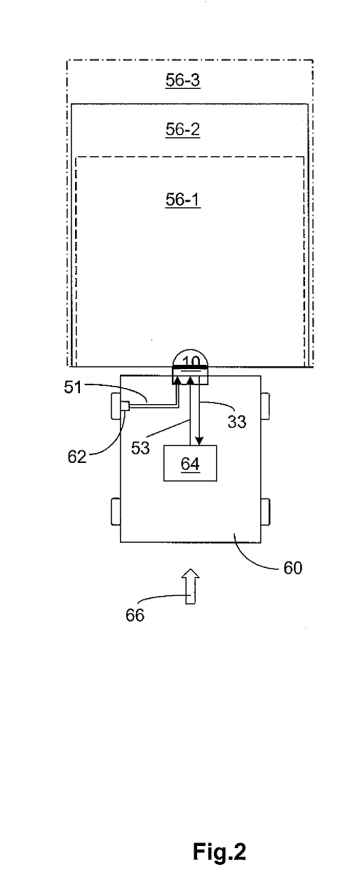

FIG. 2 a DTS with a safety scanner in accordance with the invention.

The safety scanner described in the following serves for the securing of the environment of a vehicle, in particular of a driverless transport system (DTS). The scanner monitors a protected field which is disposed in front of the DTS and into which no person may intrude during the travel to avoid collisions. If an unpermitted object, for example the leg of an operator, is located in the danger zone, this is thus detected by the scanner and a warning signal is output and/or the danger-producing movement is stopped, e.g. an emergency braking and/or escape maneuver is initiated via the vehicle controller.

FIG. 1 schematically shows the design of such a safety scanner 10. A light beam 14 which is generated by a light transmitter, e.g. a laser 12, and which is made up of individual light pulses is directed via a light deflection unit 16 into a detection zone 18 and is there remitted by an object which may be present. The remitted light 20 arrives back at the laser scanner 10 again and is there detected by s receiver 24 via the deflection unit 16 and by means of an optical receiving system 22. The light deflection unit 16 is made rotatable as a rule, with a motor 26 continuously rotating a rotating mirror 28. The respective angular position of the rotating mirror 28 is detected via an encoder 30. The light beam 14 generated by the laser 12 thus sweeps over the detection region 18 generated by the rotational movement. If a reflected light signal 20 received by the receiver 24 is received from the detection region 18, a conclusion can be made on the angular location of the object in the detection region 18 from the angular position of the deflection unit 30. In addition, the transit time of the individual laser light pulses of the transmitted light 14 is monitored from the transmission up to the reception of a reflection at the object and a conclusion is drawn on the distance of the object from the laser scanner 10 from the time of flight while using the speed of light. This evaluation takes place in an evaluation unit 32 which is connected for this purpose to the laser 12, to the receiver 24, to the motor 26 and to the encoder 30.

All the named functional components are arranged in a first inner housing 34 which has a front screen 36 at the front side, that is in the region of the light exit and of the light entry. The front screen 36 is set obliquely for the avoidance of direct reflections into the receiver so that the angle between the light beam 14 and the front screen 36 amounts to unequal to 90°.

The safety scanner 10 furthermore has a first input 50 which is made in this embodiment as a two-channel signal input 50 for the connection of an incremental encoder 62. First signals, which are representative of an actual speed of the vehicle, are received via the input 50. A second input 52 is furthermore provided which is preferably made as a single-channel input 52. Desired speed signals are transferred via this second input 52. The inputs 50 and 52 are connected to a vehicle speed determination unit 32-3 of the evaluation unit 32. The vehicle speed is determined in the vehicle speed determination unit 32-3 in a failsafe manner in the sense of the standards with reference to the first signals and desired speed signals transferred via these inputs 50 and 52, as is described in detail further below.

All the data are processed in the evaluation unit 32 in order ultimately to be able to provide a safety signal at a line 33 at an output 54.

The evaluation unit 32 calculates the location of an object in the detection region 18 via the angle and distance data so that two-dimensional protected fields 56 in the detection range 18 of the safety scanner 10 can be completely monitored in this manner as to whether an unpermitted object is located in the protected zone 56 or whether the protected field is free. The respective protective field 56 is defined in its dimensions by corresponding parameters which are stored in a memory 58 in the evaluation unit 32. An emergency braking and/or an escape maneuver of the DTS can thus ultimately be effected, for example, in dependence on the safety signal at the output 54 of the laser scanner 10.

In FIG. 2, the safety scanner 10 in accordance with the invention is shown in an application at a DTS 60. The DTS 60 has four wheels and the already mentioned incremental encoder 62 as well as a vehicle control unit 64. The vehicle control unit 64 controls the vehicle 64 as a whole, that is sets accelerations, steering movements, speeds and the like. The safety scanner 10 in accordance with the invention for the securing of the environment of the DTS is arranged at its front side so that the DTS does not collide with other objects, in particular persons. If the vehicle 60 can only move in one direction, one scanner 10 at the front side is sufficient; otherwise a further scanner for the securing of the environment on reverse travel could also be arranged at the oppositely disposed rear side.

The scanner 10 is connected at its input 50 via a line 51 to the incremental encoder 62 and at its input 52 via a line 53 to the vehicle control unit 64. The output 54 is likewise connected via the line 33 to the vehicle control unit 64 to be able to transfer the safety signal.

When the DTS 60 moves in direction 66, the scanner 10 detects the then current actual vehicle speed via the line 51. At the same time, the desired vehicle speed preset by the vehicle control unit 64 is detected via the line 53. It is preferably transferred as a binary signal. If these speeds agree within the framework of preset tolerances, which takes place via comparison means 32-2 in the evaluation unit 32, one of a plurality of protected fields 56 stored in the memory 58 is selected and activated in dependence on this speed and, optionally, on the direction of travel. This can take place via suitable switchover means 32-1. In FIG. 2, three such protected fields 56-1, 56-2 and 56-3 are shown simultaneously by way of example. For larger speeds, for example, a larger protected field 56-3 is used than for lower speeds at which a smaller protective field 56-1 is sufficient.

If the scanner 10 detects an unpermitted object in the activated protected field 56, the safety signal is output, whereupon the vehicle control 64 can initiate an emergency stop or a braking maneuver or an escape maneuver.

A safety signal is likewise output when it is determined using the comparison means 32-2 in the vehicle speed determination unit 32-3 of the evaluation unit 32 that the desired speed and the actual speed differ by a preset limit value. In an embodiment of the invention, this difference can be tolerated for a preset limited time period so that, for example, a safety signal is not output on every jerky acceleration and an emergency stop is not triggered every time.

In a further development of the invention, the safety signal can be made so that it can be recognized with reference to the signal either whether the protected field is being infringed by an unpermitted object or whether a desired speed and an actual speed are unequal. The reactions of the system can optionally be designed differently.

If the desired speed differs from the actual speed, the higher speed is preferably always used for the dimensioning of the protected field or for the selection of a protected field. It is then ensured that the system is always on the safe side and that sufficient time is present for an emergency stop.

1. A safety scanner (10) for the securing of the environment of a vehicle, in particular of a driverless transport system (60), comprising
a light transmitter (12);
a light deflection unit (16) for the deflection of the light into a protected field (56) to be monitored;
a receiver (24) for the provision of received signals in dependence on light remitted at objects present in the field of view of the scanner (10);
an evaluation unit (32) for the evaluation of the received signals and of the incremental encoder signals and for the provision of a safety signal;
a first input (50) connected to a vehicle speed determination unit (32-3) for the reception of first signals which are representative of a vehicle speed;
switchover means (32-1) for the safe switching over between at least two different protected fields (56-x) in dependence on the vehicle speed,
wherein
a second input (52) is connected to the vehicle speed determination unit (32-3) for the reception of desired speed signals of the vehicle (60) and the vehicle speed determination unit (32-3) has comparison means (32-2) with which an actual speed can be compared with a desired speed on the basis of the first signals and of the desired speed signals and the safety signal can also be output in dependence on this comparison.

2. A safety scanner in accordance with claim 1, wherein the second input (52) has a single channel.

3. A safety scanner in accordance with claim 2, wherein the second input (52) is made for the reception of binary signals.

4. A safety signal in accordance with claim 2, wherein the second input (52) and/or the first input is or are made for connection to a bus system.

5. A safety scanner in accordance with claim 1, characterized in the protected fields (56-1, 56-2, 56-3) differ in their dimensions.

6. A method for the securing of the environment of a vehicle, in particular of a driverless transport system (60), having a safety scanner (10), comprising the steps:
transmission and deflection of a light beam (14) into a protected field (56-x) to be monitored;
reception of light remitted at objects present in the field of view of the scanner (10) and provision of received signals;
evaluation of the received signals and provision of a safety signal in dependence thereon;
reception of first signals which are representative of an actual speed of the vehicle (60);
reception of desired speed signals of the vehicle;
determination of a vehicle speed by a comparison of the actual speed with the desired speed on the basis of the first signals and of the desired speed signals;
output of the safety signals also in dependence on this comparison;
switching over between at least two different protected fields in dependence on the vehicle speed.

7. A method in accordance with claim 6, wherein the safety signal is output on a deviation of the actual speed from the desired speed by more than one limit value.

8. A method in accordance with claim 7, wherein a deviation of the desired speed from the actual speed over the limit value is tolerated for a limited time duration.

9. A method in accordance with claim 6, wherein the higher speed is used for the dimensioning of the protected field or for the selection of a protected field on a deviation of the desired speed from the actual speed.

10. A method in accordance with claim 6, wherein the desired speed signal is made as a binary pattern.
